(19) United States
(12) Patent Application Publication
(10) Pub. No.: US 2018/0020160 A1
(43) Pub. Date: Jan. 18, 2018

(54) 360-DEGREE PANORAMIC CAMERA MODULE AND DEVICE

(71) Applicant: SUYIN OPTRONICS CORP., NEW TAIPEI CITY (TW)

(72) Inventors: CHEN-YI LIN, NEW TAIPEI CITY (TW); KUANG-LIANG CHANG, NEW TAIPEI CITY (TW); CHIA-HSIANG LEE, NEW TAIPEI CITY (TW); SHIH-HENG WEI, NEW TAIPEI CITY (TW)

(21) Appl. No.: 15/294,170

(22) Filed: Oct. 14, 2016

(30) Foreign Application Priority Data
Jul. 18, 2016 (TW) 105122627

(51) Int. Cl. H04N 5/232; H04N 5/225; H04N 5/247

(52) U.S. Cl. CPC H04N 5/23238; H04N 5/247; H04N 5/2252; H04N 5/2254

(57) ABSTRACT

A 360-degree panoramic camera device for taking a 360-degree panoramic image in a once-through operation includes a first case, a second case connected with the first case, and a panoramic camera module located between the first case and the second case. The panoramic camera module includes a circuit board, a first camera module fixed on the circuit board and capturing a first image in a first direction through the first case, and a second camera module fixed on the circuit board and capturing a second image in a second direction through the second. case. The first direction is opposite the second direction. A first optical axis of the first camera module and a second optical axis of the second camera module are misaligned from a straight line and are parallel to each other.

### FIELD OF THE DISCLOSURE

The present invention relates to camera modules, and more particularly to 360-degree panoramic camera modules and devices.

### BACKGROUND

An existing 360-degree panoramic camera device is designed with a dual lens module located on a front side and a hack side. Two fish-eye images are captured from the front side and the back side, and are combined together into a 360-degree panoramic image by software. The dual lenses are aligned with each other along a straight line, and the optical axes are overlapping, such that the dual lens module will occupy a certain height, thereby increasing the thickness of the 360-degree panoramic camera device. Thus, it will be inconvenient to carry, and it cannot meet the demand for making an electronic apparatus thin and light weight.

Accordingly, it is necessary to provide a 360-degree panoramic camera module and a 360-degree panoramic camera device which can decrease the height of the dual lens module so as to decrease the thickness of the 360-degree panoramic camera module and the 360-degree panoramic camera device.

### SUMMARY OF THE INVENTION

In order to solve the technical problems mentioned above, an object of the present invention is to provide a 360-degree panoramic camera device with a small volume, so as to manufacture a compact panoramic camera device, which is easy to carry and use. The camera device can not only take a 360-degree panoramic picture, but can also be used in 360-degree panoramic video recording.

According to an embodiment of the present invention, a 360-degree panoramic camera device is provided for taking a 360-degree panoramic image in a once-through operation. The device includes a first case, a second case connected with the first case, and a panoramic camera module located between the first case and the second case. The panoramic camera module comprises a circuit board, a first camera module fixed on the circuit board and capturing a first image in a first direction through the first case, and a second camera module fixed on the circuit board and capturing a second image in a second direction through the second case, where the first direction is opposite the second direction. A first optical axis of the first camera module and a second optical axis of the second camera module are misaligned from a straight line and are parallel to each other.

According to the embodiment of the present invention, a first bottom of the first camera module is located on a first plane, and a second bottom of the second camera module is located on a second plane, and there is a staggered distance L between the first plane and the second plane. The stagger distance L is measured from the first plane along a direction toward the first lens module to reach the second plane.

According to the embodiment of the present invention, the first camera module and the second camera module each have a lens, and the first camera module comprises a first substrate, and the second camera module comprises a second substrate. The first substrate and the second substrate are fixed on the circuit board. The second substrate is an L-shaped substrate.

According to the embodiment of the present invention, there is a distance D between the first bottom and the second bottom, and the first camera module and second camera module each include a height H, and the first bottom and the second bottom each include a width W, and first camera module and the second camera module each include a field of view FOV. The staggered distance L is determined by the distance D, the height H, the width W, and the field of view FOV.

According to the embodiment of the present invention, the first camera module and the second camera module each have a lens, a corresponding angle θ is formed between the field of view FOV and a horizontal plane passing through a top end of the lens. The corresponding angle θ is an acute angle. A maximum staggered distance Lmax satisfies an equation of Lmax=H−(1.5·W+D)·tanθ.

According to the embodiment of the present invention, a field of view of the first camera module does not interfere with and overlap a field of view of the second camera module which the staggered distance L is not larger than the maximum staggered distance Lmax.

According to the embodiment of the present invention, the panoramic camera module further comprises a flexible circuit board connecting the first camera module and the second camera module with the circuit board, and transmits optical signals from the first camera module and the second camera module to the circuit board, and the optical signal is processed by the circuit board.

According to the embodiment of the present invention, the circuit board comprises a micro universal serial bus (micro-USB) male connector for connecting with a handheld device.

According to the embodiment of the present invention, the circuit board comprises a micro-USB female connector for connecting with a computer.

According to another embodiment of the present invention, an assembly of a panoramic camera device and a display device is provided, comprising: a display device, and a panoramic camera device connected with the display device, an image capturing by the panoramic camera device is shown on the display device, where the panoramic camera device comprises the above-mentioned panoramic camera device.

According to the embodiment of the present invention, the display device is a virtual reality (VR) device.

According to another embodiment of the present invention, a panoramic camera module for taking a 360-degree panoramic image in a once-through operation is provided, comprising: at least one circuit board, a first camera module fixed on the at least one circuit board and capturing a first image in a first direction, and a second camera module fixed on the at least one circuit board and capturing a second image in a second direction, where the first direction is opposite the second direction. A first optical axis of the first camera module and a second optical axis of the second camera module are misaligned from a straight line.

According to the embodiment of the present invention, a first bottom of the first camera module is located on a first plane, and a second bottom of the second camera module is located on a second plane, and there is a staggered distance L between the first plane and the second plane. The stagger distance L is measured from the first plane along a direction toward the first lens module to reach the second plane. The first camera module and the second camera module each have a lens, and the first camera module comprises a first substrate, and the second camera module comprises a second substrate. The first substrate and the second substrate are fixed on the circuit board. The second substrate is an L-shaped substrate. There is a distance D between the first bottom and the second bottom, and the first camera module and second camera module each include a height H, and the first bottom and the second bottom each include a width W, and first camera module and the second camera module each include a field of view FOV. The staggered distance L is determined by the distance D, the height H, the width W, and the field of view FOV. The staggered distance L located between the first plane and the second plane is less than a maximum staggered distance Lmax which satisfies an equation of Lmax=H−(1.5·W+D)·tanθ, where θ is an acute angle formed between the field of view FOV and a horizontal plane passing through a top end of the lens.

According to the embodiment of the present invention, the at least one circuit board comprises two circuit hoards being spaced the staggered distance L apart from each other, and the first camera module and the second camera module are located on the two circuit boards respectively.

According to another embodiment of the present invention, a camera phone is provided, including a 360-degree camera module integrated therein. The 360-degree camera module is the above mentioned panoramic camera module.

### BRIEF DESCRIPTION OF THE DRAWINGS

FIG. 1 is a perspective view of a 360-degree panoramic camera device according to an embodiment of the present invention.

FIG. 2 is an exploded view of the 360-degree panoramic camera device of FIG. 1.

FIG. 3 is a top view of a panoramic camera module of the 360-degree panoramic camera device of FIG. 2.

FIG. 4 is a relative position relationship diagram of lens modules on the panoramic camera module of FIG. 3.

FIG. 5 is an exploded view of a 360-degree panoramic camera device according to another embodiment of the present invention.

FIG. 6 is a perspective view showing an application of a 360-degree panoramic camera device according to the present invention.

FIG. 7A is a front perspective view of a 360-degree panoramic camera phone according to an embodiment of the present invention.

FIG. 7B is a back perspective view of the 360-degree panoramic camera phone of FIG. 7A.

FIG. 7C is a top view of the 360-degree panoramic camera phone of FIG. 7A.

FIG. 7D is a bottom view of the 360-degree panoramic camera phone of FIG. 7A.

FIG. 7E is a side view of an upper portion of the 360-degree panoramic camera phone of FIG. 7A.

FIG. 7F is a sectional view of an upper portion of the 360-degree panoramic camera phone of FIG. 7A.

### DETAILED DESCRIPTION

In order to illustrate the technical solutions in the embodiments of the present invention more clearly, the following briefly introduces the accompanying drawings required for describing the embodiments.

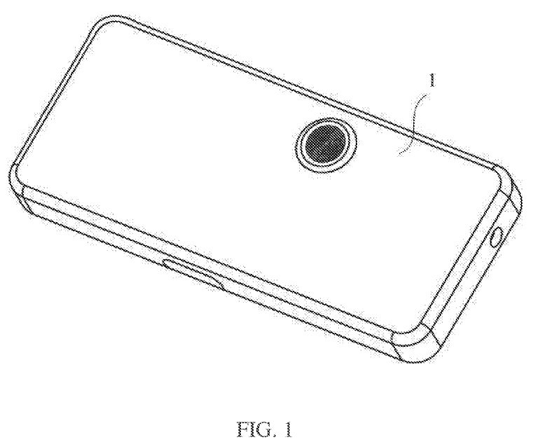

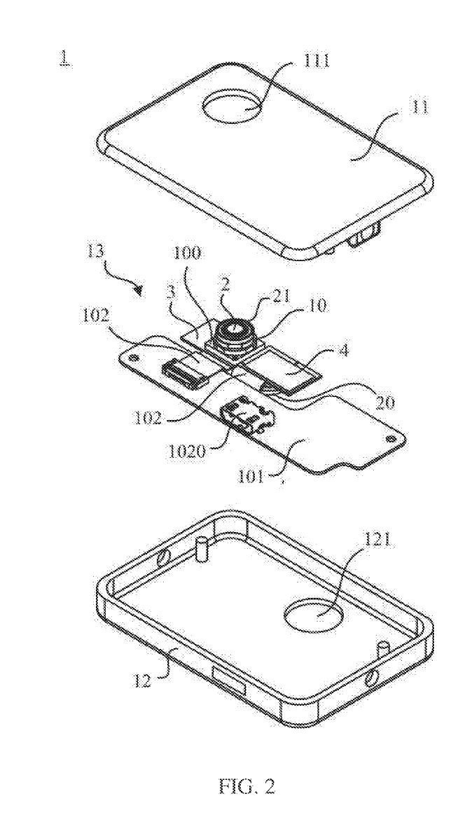

Referring to FIG. 1 and FIG. 2, FIG. 1 is a perspective view of a 360-degree panoramic camera device 1 according to an embodiment of the present invention, and FIG. 2 is an exploded view of the 360-degree panoramic camera device 1 of FIG. 1. The 360-degree panoramic camera device 1 can not only take a panoramic image, but can also be used in panoramic video recording.

As shown in FIG. 2, the panoramic camera device 1 for taking a 360-degree panoramic image in a once-through operation comprises a first case 11, a second case 12 connected with the first case 11, and a panoramic camera module 13 located between the first case 11 and the second case 12. The panoramic camera module 13 comprises a circuit hoard 101, a first camera module 10 fixed on a first substrate 3 and capturing a first image in a first direction through a first through-hole 111 of the first case 11, and a second camera module 20 fixed on a second substrate 4 and capturing a second image in a second direction through a second through-hole 121 of the second case 12, where the first direction is opposite the second direction.

The first camera module 10 and the second camera module 20 each have a lens 2 screwed together with a sleeve 21. The focus of the first camera module 10 and the second camera module 20 can be adjusted by rotating the corresponding lens 2 in relative to the corresponding sleeve 21. The first camera module 10 and second camera module 20 also comprise the first substrate 3 and the second substrate 4 respectively. The second substrate 4 is an L-shaped substrate, so there is a staggered distance between the first and second camera modules (it will be explained later in detail). The first substrate 3 and the second substrate 4 are fixed on the circuit board 101 by a welding connection or a glue connection.

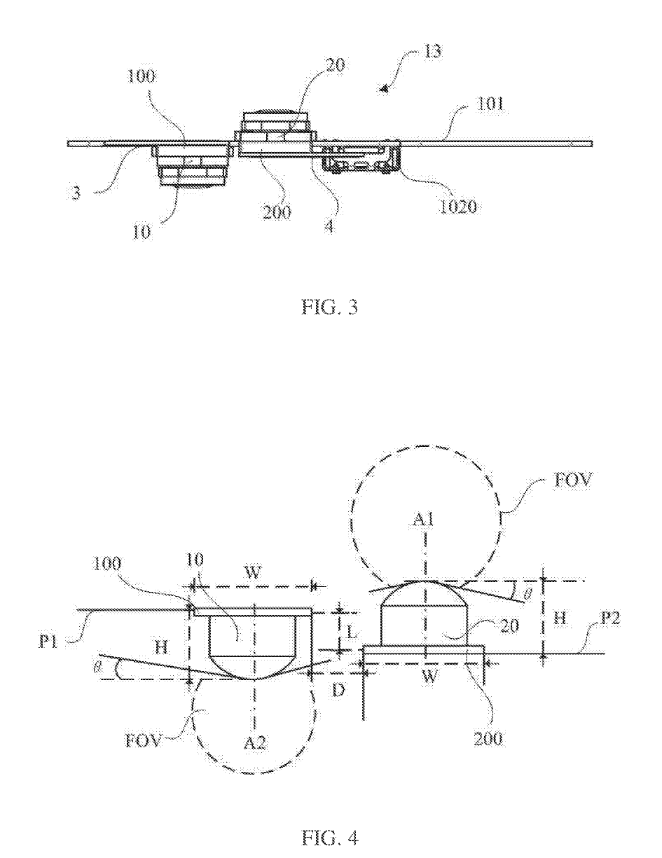

In FIG. 3, which is a top view of a panoramic camera module of the 360-degree panoramic camera device 1 of FIG. 2, in which a first bottom 100 of the first camera module 10 and a second bottom 200 of the second camera module 20 are shown. The first bottom 100 is fixed on the first substrate 3, and the second bottom 200 is fixed on the second substrate 4, which can be achieved by a welding connection or a glue connection. The first substrate 3 is aligned with the circuit board 101, and the second substrate 4 is spaced a distance apart from the circuit board 101.

Preferably, the panoramic camera module 13 also comprises two flexible circuit boards 102 for connecting the first camera module 10 and the second camera module 20 with the circuit board 101. Optical signals acquired from the first camera module 10 and the second camera module 20 (i.e., images acquired from two lens modules) are transmitted to the circuit hoard 101 via the two flexible circuit boards 102, so as to process the optical signals.

Preferably, the circuit board 101 comprises a micro USB female connector 1020 for connecting with a computer for processing data and playing images. It is known in the art that the connector may be a male connector for connecting with an electronic device, such as a smart phone or a virtual reality (VR) device. Furthermore, the 360-degree panoramic camera device 1 of the present invention can include a signal process chip, a display chip, and a screen, such that the 360-degree panoramic images or videos acquired by the lens modules 10 and 20 can be directly shown.

FIG. 4 is a relative position relationship diagram of lens modules 10 and 20 on the panoramic camera module 13 of FIG. 3. The first bottom 100 of the first camera module 10 is located on a first plane P1, and a second bottom 200 of the second camera module 20 is located on a second plane P2. The first plane P1 and the second plane P2 are spaced a staggered distance L apart from each other in a vertical direction. The stagger distance L is measured from the first plane P1 along a direction toward the lens 2 of the first lens module 10 to reach the second plane P2. A first optical axis A1 of the first camera module and a second optical axis A2 of the second camera module are misaligned from each other; the first and second optical axes A1, A2 are not on a same straight line and are parallel to each other.

Preferably, two adjacent ends of the first bottom 100 and the second bottom 200 are spaced a distance D apart from each other in a horizontal direction. The first camera module 10 and the second camera module 20 each have a height H. The first bottom 100 and the second bottom 200 each have a width W. The first camera module 10 and the second camera module 20 each have a field of view FOV. corresponding angle θ is formed between the field of view FOV and a horizontal plane passing through a top end of the lens 2. The corresponding angle θ is art acute angle. In FIG. 4, a symbol θ is designated as the corresponding angle. The staggered distance L is determined by the distance D, the height H, the width W, and the field of view FOV. A maximum value of the staggered distance L, i.e. a maximum staggered distance Lmax, is determined by the following equation:

Lmax=H−(1.5·W+D)·tanθ

Preferably, the staggered distance L between the first plane 100 and the second plane 200 should be less than the maximum staggered distance Lmax. Thus, a field of view of the first camera module 10 does not interfere with and overlap a field of view of the second camera module 20. That is, the maximum staggered distance Lmax is an optimum value of the staggered distance. In the two images respectively acquired from the two lens modules, there is no overlapping image area. The greater the maximum staggered distance Lmax, the smaller the thickness of the device will be. Hence, if the staggered distance L is the maximum staggered distance Lmax, the device has a minimum thickness. As shown in FIG. 4, in comparing the 360-degree panoramic camera device 1 of the present invention and a prior art 360-degree panoramic camera device, the thickness of the device 1 in accordance with the present invention can be decreased by a distance which is less than or equal to the maximum staggered distance Lmax, so that it can meet the demand for making electronic devices thin and light weight.

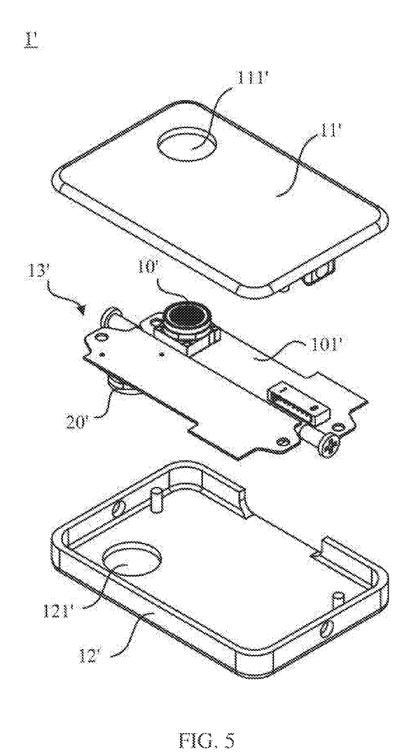

FIG. 5 is an exploded view of a 360-degree panoramic camera device 1′ according to another embodiment of the present invention. As shown in FIG. 5, the panoramic camera device 1′ for taking a 360-degree panoramic image in a once-through operation comprises a first case 11′, a second case 12′ connected with the first case 11′, and a panoramic camera module 13′ located between the first case 11′ and the second case 12′. The panoramic camera module 13′ comprises a circuit board 101′, a first camera module 10′ fixed on the circuit board 101′ and capturing a first image in a first direction through a first through-hole 111′ of the first case 11′, and a second camera module 20′ fixed on the circuit board 101′ and capturing a second image in a second direction through a second through-hole 121′ of the second case 12′, where the first direction is opposite the second direction. It differs from the above panoramic camera device 1 in that the first and second camera modules 10 and 20 are respectively directly fixed on two circuit boards 101′ which are spaced a distance apart from each other, so as to achieve the effect of the staggered distance L. In this embodiment, the first substrate 3, the second substrate 4, and the flexible circuit boards 102 of the first embodiment are omitted.

FIG. 6 is a perspective view showing an application of a 360-degree panoramic camera device 1″ according to the present invention. An assembly of the panoramic camera device 1″ and a handheld device 50 is used for taking a 360-degree panoramic image in a once-through operation. The panoramic camera device 1″ differs front the above panoramic camera device 1 in that a circuit board of the panoramic camera device 1″ comprises a micro-USB male connector for connecting the panoramic camera device 1″ with the handheld device 50. By installing a specific application in the handheld device 50, images can be shown on the handheld device 50 and can also be processed, so as to improve functions and applications of the panoramic camera device 1″.

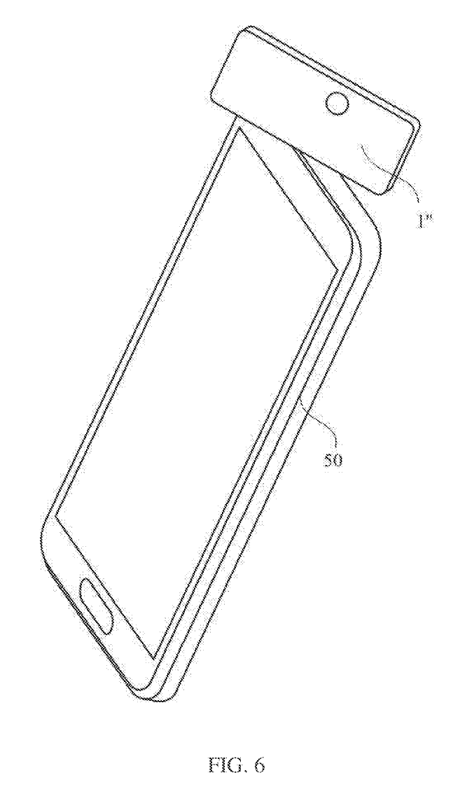

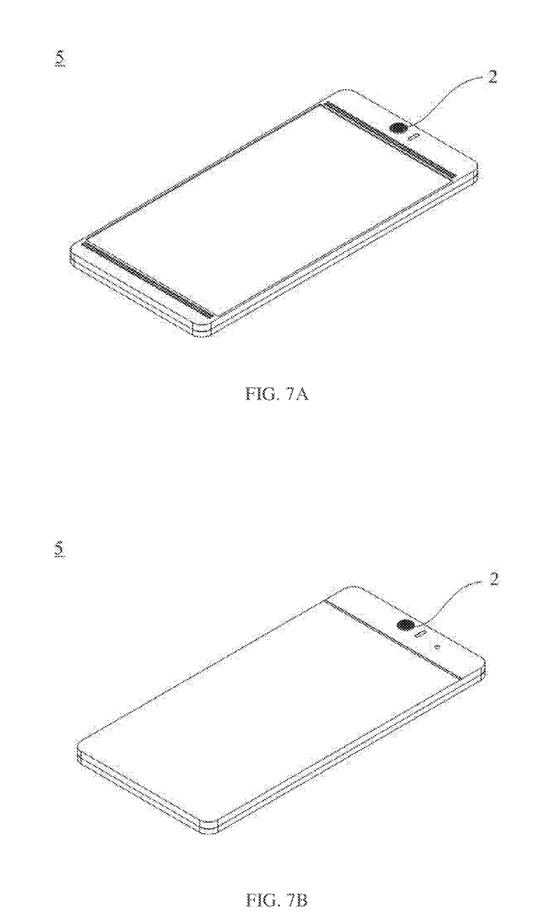

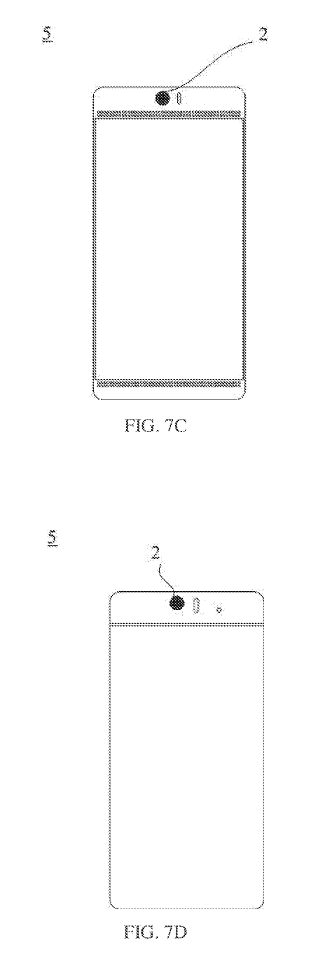

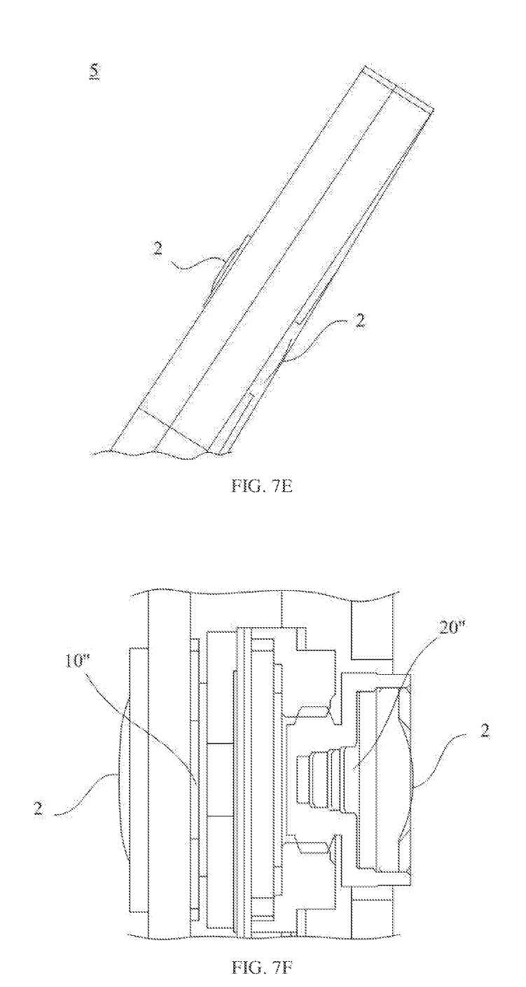

Referring to FIG. 7A to FIG. 7F, FIG. 7A is a front perspective view of a 360-degree panoramic camera phone 5 according to an embodiment of the present invention. The camera phone 5 is integrated with a 360-degree panoramic camera module according to the present invention. The lens 2 of the first camera module of the 360-degree panoramic camera module is located above a screen of the 360-degree panoramic camera phone 5. FIG. 7B is a back perspective view of the 360-degree panoramic camera phone of FIG. 7A. The lens 2 of the second camera module of the 360-degree panoramic camera module is located at a top of a back surface of the 360-degree panoramic camera phone 5, and is spaced a distance apart from the lens 2 of the first camera module. FIG. 7C is a top view of the 360-degree panoramic camera phone 5 of FIG. 7A. FIG. 7D is a bottom view of the 360-degree panoramic camera phone 5 of FIG. 7A. FIG. 7E is a side view of an upper portion of the 360-degree panoramic camera phone 5 of FIG. 7A. FIG. 7F is a sectional view of an upper portion of the 360-degree panoramic camera phone 5 of FIG. 7A. The first lens module 10″ and the second lens module 20″ of the 360-degree panoramic camera module are integrated with the camera phone 5. In this embodiment, the 360-degree panoramic camera module may be any one of the 360-degree camera module 13 or 13′, and preferably is the 360-degree camera module 13.

It is understood that the relative position of each component in the above panoramic camera module is for exemplary purposes only and is not intended to limit the scope of the invention.

In the panoramic camera module of the present invention, the front lens and back lens are disposed with different optical axes, and a maximum staggered distance is obtained according to the field of view of the two lenses, so as to decrease the thickness of the panoramic device which is compact and easy to carry and use.

The above are merely preferable embodiments of the present invention, and do not intend to limit the present invention, and any amendments, equivalent substitutions, or improvements within spirit and principle of the present invention are all included in the protection scope of the present invention.

What is claimed is:

1. A panoramic camera device for taking a 360-degree panoramic image in a once-through operation, comprising:
a first case;
a second case connected with the first case; and
a panoramic camera module located between the first case and the second case and comprising:
a circuit board;
a first camera module fixed on the circuit board and capturing a first image in a first direction through the first case; and
a second camera module fixed on the circuit board and capturing a second image in a second direction through the second case, wherein the first direction is opposite the second direction;
wherein a first optical axis of the first camera module and a second optical axis of the second camera module are misaligned from a straight line and are parallel to each other.

2. The panoramic camera device as claimed in claim 1, wherein a first bottom of the first camera module is located on a first plane, and a second bottom of the second camera is located on a second plane, and there is a staggered distance L between the first plane and the second plane, the stagger distance L being measured from the first plane along a direction toward the first lens module to real the second plane.

3. The panoramic camera device as claimed in claim 2, wherein the first camera module and the second camera module each have a lens, and the first camera module comprises a first substrate, and the second camera module comprises a second substrate; the first substrate and the second substrate are fixed on the circuit board, and the second substrate is an L-shaped substrate.

4. The panoramic camera device as claimed in claim 2, wherein there is a distance D between the first bottom and the second bottom, and the first camera module and second camera module each include a height H, and the first bottom and the second bottom each include a width W, and first camera module and the second camera module each include a field of view FOV; and wherein the staggered distance L is determined by the distance D, the height H, the width W, and the field of view FOV.

5. The panoramic camera device as claimed in claim 4, wherein the first camera module and the second camera module each have a lens, a corresponding angle θ is formed between the field of view FOV and a horizontal plane passing through a top end of the lens, the corresponding angle θ is an acute angle, and a maximum staggered distance Lmax satisfies an equation of Lmax=H−(1.5·W+D)·tanθ.

6. The panoramic camera device as claimed in claim 5, wherein the field of view of the first camera module does not interfere with and overlap the field of view of the second camera module which the staggered distance L is not larger than the maximum staggered distance Lmax.

7. The panoramic camera device as claimed in claim 6, wherein the panoramic camera module further comprises a flexible circuit board connecting the first camera module and the second camera module with the circuit board, and transmitting optical signals from the first camera module and the second camera module to the circuit board, and the optical signal is processed by the circuit board.

8. The panoramic camera device as claimed in claim 6, wherein the circuit hoard comprises a micro universal serial bus (micro-USB) male connector for connecting with a handheld device.

9. The panoramic camera device as claimed in claim 6, wherein the circuit board comprises a micro-USB female connector for connecting with a computer.

10. An assembly of a panoramic camera device and a display device, comprising:
a display device; and
a panoramic camera device connected with the display device, an image capturing by the panoramic camera device is shown on the display device, wherein the panoramic camera device comprises the panoramic camera device according to claim 1.

11. The assembly of a panoramic camera device and a display device as claimed in claim 10, wherein the display device is a virtual reality (VR) device.

12. A panoramic camera module for taking a 360-degree panoramic image in a once-through operation, comprising:
at least one circuit board;
a first camera module fixed on the at least one circuit board and capturing a first image in a first direction; and
a second camera module fixed on the at least one circuit board and capturing a second image in a second direction, wherein the first direction is opposite the second direction;
wherein a first optical axis of the first camera module and a second optical axis of the second camera module are misaligned from a straight line.

13. The panoramic camera module as claimed in claim 12, wherein a first bottom of the first camera module is located on a first plane, and a second bottom of the second camera module is located on a second plane, and there is a staggered distance L between the first plane and the second plane, the stagger distance L being measured from the first plane along a direction toward the first lens module to reach the second plane.

14. The panoramic camera module as claimed in claim 13, wherein the first camera module and the second camera module each have a lens, and the first camera module comprises a first substrate, and the second camera module comprises a second substrate, the first substrate and the second substrate are fixed on the circuit board, and the second substrate is an L-shaped substrate.

15. The panoramic camera module as claimed in claim 14, wherein there is a distance D between the first bottom and the second bottom, and the first camera module and second camera module each include a height H, and the first bottom and the second bottom each include a width W, and first camera module and the second camera module each include a field of view FOV, and wherein the staggered distance L is determined by the distance D, the height H, the width W, and the field of view FOV.

16. The panoramic camera module as claimed in claim 15, wherein the staggered distance L located between the first plane and the second plane is less than a maximum staggered distance Lmax which satisfies an equation of Lmax=H−(1.5·W+D)·tanθ, wherein θ is an acute angle formed between the field of view FOV and a horizontal plane passing through a top end of the lens.

17. The panoramic camera module as claimed in claim 16, wherein a field of view of the first camera module does not interfere with and overlap a field of view of the second camera module.

18. The panoramic camera module as claimed in claim 13, wherein the at least one circuit board comprises two circuit boards being spaced the staggered distance L apart from each other, and the first camera module and the second camera module are located on the two circuit hoards respectively.
